(19) United States
(12) Patent Application Publication
(10) Pub. No.: US 2003/0113697 A1
(43) Pub. Date: Jun. 19, 2003

(54) Computerized management system for maintaining compliance with educational guidelines for special and regular education students

(76) Inventor: Gary Plescia, Medford, NJ (US)

Correspondence Address: Sperry, Zoda & Kane, Suite D, One Highgate Drive, Trenton, NJ, 08618, US

(21) Appl. No.: 09/929,841

(22) Filed: Aug. 14, 2001

(51) Int. Cl. G09B 3/00; G09B 7/00

(52) U.S. Cl. 434/322

(57) ABSTRACT

The system of the present invention is a comprehensive aid to special education within school districts to facilitate the managing, monitoring and assessing of their special education program on an ongoing basis by demonstrating levels of compliance with guidelines set forth by Federal and State administrative agencies. This system provides a computerized database for individually managing special education students and monitoring their progress while automatically rendering regular reports and evaluation while also designing and updating the individual education plans for each student as well as continually upgrading lesson plans in accordance with all federal mandates and state regulations.

### BACKGROUND OF THE INVENTION

1. Field of the Invention

The present invention deals with the field of computerized management systems used within the field of education for the purposes of evaluating district compliance of education programs and district ability to manage, monitor and assess the effectiveness of education programs by evaluating special and regular education students progress individually as well as other designated populations.

In recent years the number of Federal and State guidelines setting forth requirements in special education curriculum has significantly expanded such that it is becoming more and more difficult for a school district to monitor their compliance with all requirements. The present invention provides a computerized management system for maintaining compliance by managing, monitoring and assessing a special education program and comparing it to the required standards set forth in State and Federal guidelines.

2. Description of the Prior Art

Computerized management system have been used for many purposes in a wide variety of business, commercial and educational fields such as shown in U.S. Pat. No. 4,787,036 patented Nov. 22, 1988 to Patrick J. Fleming on a “Student Enrollment Stabilization System”; and U.S. Pat. No. 4,829,431 patented May 9, 1989 to Granville E. Ott et al and assigned to Texas Instruments Incorporated on a “Method And Apparatus For Correlating Test Information”; and U.S. Pat. No. 5,218,535 patented Jun. 8, 1993 to David A. Pietrowski on a “Method And Apparatus For Data Acquisition”; and U.S. Pat. No. 5,437,553 patented Aug. 1, 1995 to Deborah L. Collins et al on a “Method And Apparatus For Automated Learning And Performance Evaluation”; and U.S. Pat. No. 5,577,919 patented Nov. 26, 1996 to Deborah L. Collins et al on a “Method And Apparatus For Automated Learning And Performance Evaluation”; and U.S. Pat. No. 5,745,885 patented Apr. 28, 1998 to Anthony J. Mottola et al and assigned to Human Capital Resources, Inc. on a “Data Storage Medium For Funding Education By Acquiring Shares Of Students' Future Earnings”; and U.S. Pat. No. 5,749,736 patented May 12, 1998 to Michael R. Griswold et al and assigned to Taras Development on a “Method And System For Computerized Learning, Response, And Evaluation”; and U.S. Pat. No. 5,797,133 patented Aug. 18, 1998 to Robert M. Jones et al and assigned to Strategic Solutions Group, Inc. on a “Method For Automatically Determining The Approval Status Of A Potential Borrower”; and U.S. Pat. No. 5,809,484 patented Sep. 15, 1998 to Anthony J. Mottola et al and assigned to Human Capital Resources, Inc. on a “Method And Apparatus For Funding Education By Acquiring Shares Of Students Future Earnings”; and U.S. Pat. No. 5,878,405 patented Mar. 2, 1999 to James K. Grant et al and assigned to Coordinated Data Services, Inc. on a “Pension Planning And Liquidity Management System”; and U.S. Pat. No. 5,897,627 patented Apr. 27, 1999 to Robert H. Leivian et al and assigned to Motorola, Inc. on a “Method Of Determining Statistically Meaningful Rules”; and U.S. Pat. No. 5,897,630 patented Apr. 27, 1999 to Lynn Virta et al and assigned to International Business Machines Corporation on a “System And Method For Efficient Problem Determination In An Information Handling System”; and U.S. Pat. No. 5,909,684 patented Jun. 1, 1999 to Douglas C. Nelson and assigned to MCI Communications Corporation on a “System, Method, And Computer Program Product For Creating A Platform Independent Notebook Control”; and U.S. Pat. No. 5,974,255 patented Oct. 26, 1999 to D. Gossain et al and assigned to Motorola, Inc. on a “Method For State-Based Oriented Testing”; and U.S. Pat. No. 5,978,780 patented Nov. 2, 1999 to C. Watson and assigned to Craig Michael Watson on an “Integrated Bill Consolidation, Payment Aggregation, And Settlement System”; and U.S. Pat. No. 5,978,786 patented Nov. 2, 1999 to Donald Eyles and assigned to The Charles Stark Draper Laboratory, Inc. on a “System And Method For Automatically Executing Decisional Rules”; and U.S. Pat. No. 5,978,798 patented Nov. 2, 1999 to Victor Poznanski et al and assigned to Sharp Kabushiki Kaisha on an “Apparatus For And Method Of Accessing A Database”.

### SUMMARY OF THE INVENTION

A computerized management system is set forth in the present invention for the purposes of managing, monitoring and assessing the progress of a school system in educating their special education students and other designated populations while demonstrating compliance with State and Federal special education guidelines. This system allows the school district to demonstrate the efficacy of their programs for special and regular population education and greatly improve the effectiveness of supervision over all programs. It has the capability for aligning district curriculum with any State curricula standards and creating a meaningful collaboration between the district and the parents of the individual special education students. This system achieves this purpose while at the same time maintaining inclusion of all State required procedural safeguards. The system includes all requirements for a school district to provide access to regular education curriculum as well as automating correlation thereof with any State curriculum standards.

This monitoring system has the capability of tracking all steps of the initial meeting and evaluation plan eligibility determination, and subsequent evaluations and individual education plans. It has the capability for identifying areas of weakness and providing a unique alarm for notification that an out of compliance situation has developed or an out of compliance situation is about to develop.

The system has the capability of merging parent input throughout the process to maintain full communication between the faculty and the parents of the special education student. For this purpose automated parental correspondence is generated at various points during the managing of the special education curricula. Student records are updated with all activities, letters and conversations to provide a fully updated record of anecdotal information.

One of the most important aspects of the present invention is to provide an automatic customized individual education plan. This plan is customized for a particular student and defines specific district identified or individually created benchmarks and objectives of the district curricula. The individual education plan links related services to the district curricula and the State standards.

The system of the present invention provides the capability to measure the effectiveness of specific interventions in the classrooms. It provides continuous support for the student's development by monitoring objectives which have yet to be mastered.

One of the most important aspects of the present invention is the ability to monitor individual education plan interventions and modifications. Every individual education plan program modification and/or accommodation is captured and recorded into a computerized matrix system which provides access to the classroom teacher(s) to document the implementation of the selected modifications and accommodations as they occur in the classroom, subject by subject, student by student. This actually provides the teacher an automated means of documenting the implementation of the individual education plan into the classroom. The teacher's opinion is recorded in terms of whether or not the intervention was effective, along with anecdotal records, and teachers concerns. A complete report is automatically generated and ready to print.

A statistical analysis of the efficacy of interventions is another important advantage of the present system. The present applicant does not stop at merely recording the interventions in the classroom for each student. The next step is to statistically analyze the information and provide a complete report indicating the rate of success of each intervention, and to reflect to the team, which interventions are most helpful and which interventions are not working. This report analyses the % of effectiveness of the interventions in the classroom, every day, subject by subject. This information is available to administrators, to help assess the effectiveness of teacher performance/individual education plan interventions/student compliance and performance. In this way the system provides the means for the teacher to record and the district to demonstrate the efficacy of the interventions delivered in the classroom.

It is also possible under the method of the present invention to provide a lesson plan system for monitoring individual education plan benchmarks and objectives. The next step is demonstrating the efficacy of your special education programs is to tie your lesson plans directly to the objectives and benchmarks in each student's individual education plan, and monitor each student's progress on a daily basis. And, that is exactly what the present applicant does. Through a simple yet efficient means, the present applicant provides each teacher with the ability to write a lesson plan for the entire class that is also tailored to meet the demands of the individual education plan objectives and benchmarks for each student. The objections/benchmarks are automatically available to each teacher for all students entered into the system through the development of an individual education plan.

The goals, objectives and benchmarks set forth in the present method can be easily subjected to statistical analysis in accordance with the present invention. It could only get better if the information from the lesson plans were automatically recorded, along wit each student's actual progress each day; and then these progress indicators were electronically analyzed to determine when each objective was actually met. These objectives/benchmarks, evaluative criteria, and instructional materials are automatically available to the teacher to include in the class lesson plan. After the lesson is complete, the teacher indicates levels of mastery for each objective, and the reason for the level of achievement, along with any anecdotal record. This information is automatically entered into a progress report, available for printing or e-mail. The present applicant provides a progress report automatically for each student, which reflects those objectives presented in class, those mastered, those in progress, and those not yet attempted.

The total assessment and educational management system disclosed herein also provides automated diary entries and calendar scheduling. State reports can be produced automatically at any time and statistic analysis are automatically made available in all of the important areas.

The system further provides the ability to assess student growth and achievement and generate reports for showing progress and monitoring scoring on standardized tests and relating these to overall academic progress. The program further provides information which is important to aid in the allocation of resources and teaching materials throughout the special education environment.

Initially the system records all data to assist in the determination whether the current student has needs at the current time for special education. This initial determination may include the generation of a present level of performance report and also usually includes an initial evaluation meeting which may include the parents of the special education student.

In those specific situations where special education is not deemed warranted an individual education plan clearly then is not needed and review of the student is terminated and a re-evaluation time period is chosen. On the other hand, if it is determined that special education needs are present, then an individual education plan is provided for the student which establishes goals which may be annual or over other time periods and specific benchmarks and objectives which are intended to be reached by the student during the applicable time period for the individual education plan.

The instructional criteria is then evaluated for the purpose of facilitating the student in meeting the benchmarks and objectives set forth in the customized individual education plan. A specific lesson plan is created which correlates to the instructional criteria for the specific student. Instruction materials are listed and available in the lesson plan system. The costs of the instruction materials can, if desired, be allocated to the specific student in order to more accurately monitor costs.

An inventory of the instructional materials is maintained and is continuously updated by the teachers as needed through a purchase order system. Students are then placed within a specific teaching group currently working on similar lesson plans. Specific criteria areas are established for the purpose of evaluating the progress of a student toward meeting the objectives and benchmarks of his or her individual education plan. Student evaluations are recorded and tests are given to determine progress and the development of the student's mastery toward the individual benchmarks and objectives of his personalized individual education plan. Also the teacher will record the master level of the student subsequent to specific lessons based on predetermined evaluation criteria.

The teacher will normally establish that the student has no mastery of the subject matter, has a limited exposure, has partial mastery or has full mastery of the subject matter. These four subjective determination levels are made by the teacher who will allow the individual education plan team to compare the indicated mastery level and benchmarks and objectives to standardized test results or alternative assessments. The objective ancillary test results and student grades will be compared to these same criteria. At this point a determination will be made whether the student has achieved the predetermined annual goals. If not, a final report can be rendered indicating successful completion of the educational activity and a time period for re-evaluation can be created. If, however, annual goals have not been met then the lesson plan will continue to present the yet to be determined objectives.

At this point a written report will be rendered on the student's progress in attempting to meet the benchmarks and objectives of the individual education plan and lesson plan modifications will be suggested. The student's records will then automatically be forwarded in the process of annual review, re-evaluation, and/or declassification to determine whether an alarm needs to occur based on compliance of the required special education schedule and guidelines set forth by State or Federal authorities. Thereafter the benchmarks and objectives generally set forth by the special education guideline authority will be updated to the most current information. A progress report can then be generated which evaluates and analyzes the levels of all students in the database in progressing toward the benchmarks and objectives of their individual education plan. At this point the instructional criteria and student progress can be evaluated for the purposes of determining what is needed in order to facilitate a student in attaining the established benchmarks and objectives of his special education plan. The cycle can be repeated until the student is determined to have successfully reached all benchmarks and objectives of his plan, or a new individual education plan is written.

It is an object of the computerized management system for maintaining compliance with predetermined guidelines for providing individualized education administered to special education students and for the present invention to provide a fully automated means for demonstrating compliance with all State and Federal requirements.

It is an object of the computerized management system for demonstrating the efficacy of an individual education plan administered to special education students and/or other designated populations and to provide a system which is simple to learn and easy to use.

It is an object of the computerized management system for maintaining compliance with predetermined guidelines for providing individualized education administered to special education students of the present invention to provide a means for allowing the district to flexibly update letters, objectives, program modifications and individual education plan wording as needed.

It is an object of the computerized management system for maintaining compliance with predetermined guidelines for providing individualized education administered to special education students of the present invention using drop down boxes for point and clip entry as well as free form input capability.

It is an object of the computerized management system for maintaining compliance with predetermined guidelines for providing individualized education administered to special education students of the present invention which is usable with conventional IBM-compatible and MacIntosh system computers.

It is an object of the computerized management system for maintaining compliance with predetermined guidelines for providing individualized education administered to special education students of the present invention which can be conveniently installed on an individual personal computer or on a network computer.

It is an object of the computerized management system for maintaining compliance with predetermined guidelines for providing individualized education administered to special education students of the present invention which is in full compliance with the latest changes in Federal and State special education statutes.

It is an object of the computerized management system for maintaining compliance with predetermined guidelines for providing individualized education administered to special education students of the present invention which enhances supervision of the effectiveness of special and regular education programs.

It is an object of the computerized management system for maintaining compliance with predetermined guidelines for providing individualized education administered to special education students of the present invention which avoids the frustration of paper-based systems attempting to monitor compliance with authoritative guidelines.

It is an object of the computerized management system for maintaining compliance with predetermined guidelines for providing individualized education administered to special education students of the present invention which is cost effective and efficient.

It is an object of the computerized management system for maintaining compliance with predetermined guidelines for providing individualized education administered to special education students of the present invention which provides all reports necessary for State and Federal administrative agencies, and for Medicaid tracking reimbursement.

It is an object of the computerized management system for maintaining compliance with predetermined guidelines for providing individualized education administered to special education students of the present invention which is usable for any student, not just special education students.

It is an object of the computerized management system for maintaining compliance with predetermined guidelines for providing individualized education administered to special education students of the present invention which can transfer data electronically between schools within a system and between school systems.

It is an object of the computerized management system for maintaining compliance with predetermined guidelines for providing individualized education administered to special education students of the present invention which can generated statistical reports for all students.

It is an object of the computerized management system for maintaining compliance with predetermined guidelines for providing individualized education administered to special education students of the present invention which provides a matrix report on modification or accommodations monitoring the progress of all students.

It is an object of the computerized management system for maintaining compliance with predetermined guidelines for providing individualized education administered to special education students of the present invention which creates individual education plan progress reports automatically based on student progress in lesson plans.

It is an object of the computerized management system for maintaining compliance with predetermined guidelines for providing individualized education administered to special education students of the present invention which creates student data for defining the learning curves.

It is an object of the computerized management system for maintaining compliance with predetermined guidelines for providing individualized education administered to special education students of the present invention which supports the individual education plan uniquely designed for each student.

### BRIEF DESCRIPTION OF THE DRAWINGS

While the invention is particularly pointed out and distinctly claimed in the concluding portions herein, a preferred embodiment is set forth in the following detailed description which may be best understood when read in connection with the accompanying drawings, in which:

FIG. 1 is a flowchart showing the system of the present invention for the creation of individual education plans, lesson plans and making program modifications and generating reports;

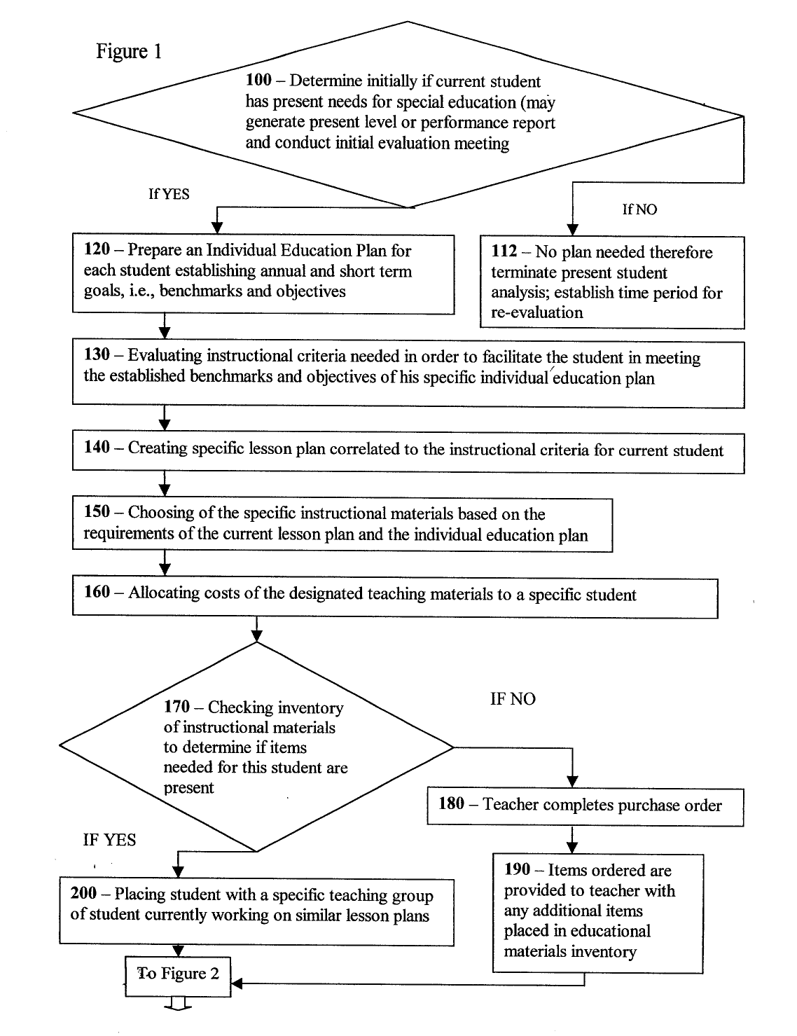

FIG. 2 is an extension of the flowchart shown in FIG. 1;

FIG. 3 is a decision flowchart;

FIG. 4 is a flowchart for the processing steps for an incoming student who is a new referral and is an extension of the flowchart shown in FIG. 3;

FIG. 5 is a flowchart showing the processing steps for an incoming transfer student who already has an individual education plan and is another extension of the flowchart shown in FIG. 3;

FIG. 6 shows tables detailing the activities that take place from convening of the final meeting to completion of the process.

### DETAILED DESCRIPTION OF THE PREFERRED EMBODIMENT

The computerized management system of the present invention includes an initial determination shown at query 100 wherein it determined whether the student currently being considered has special needs such that special education is warranted. This step 100 can include the generation of a PLP (present level of performance) report. This initial determination also may include the conducting of an initial evaluation meeting including educational professionals, curriculum coordinators and usually the parents of the student.

If it is determined that no special education is required step 110 will be followed wherein no plan will be needed and analysis of the particular student will be terminated and a specific time period can be established for re-evaluation.

On the other hand, however, if it is determined that there is a need for special education the system will proceed to step 120. In step 120 and individual education plan is prepared for the particular student. This plan is a customized plan prepared particularly for the student under current consideration which establishes, in the form of benchmarks and objectives, and determines the current goals of the special education for that particular student. Once the individual education plan or IEP is completed, the instructional criteria will be established as needed in order to facilitate the student in meeting the established benchmarks and objectives set forth in the IEP. This is step 130. Step 140 will include the creating of a specific plan correlated to the instructional criteria for the specific student. Thereafter in step 150 the specific instructional materials will be chosen based on the selected lesson plan. In step 160 the cost of the designated teaching materials can be allocated to the specific student which can aid in rendering cost projection reports and cost effectiveness reports.

Once the designated teaching materials are chosen the inventory of instructional materials is reviewed at step 170 to determine if items for the student are present. If the items are not present the teacher will complete a purchase order and items ordered will be provided to the teacher at step 180. Additional materials will be placed into the inventory for possible future use.

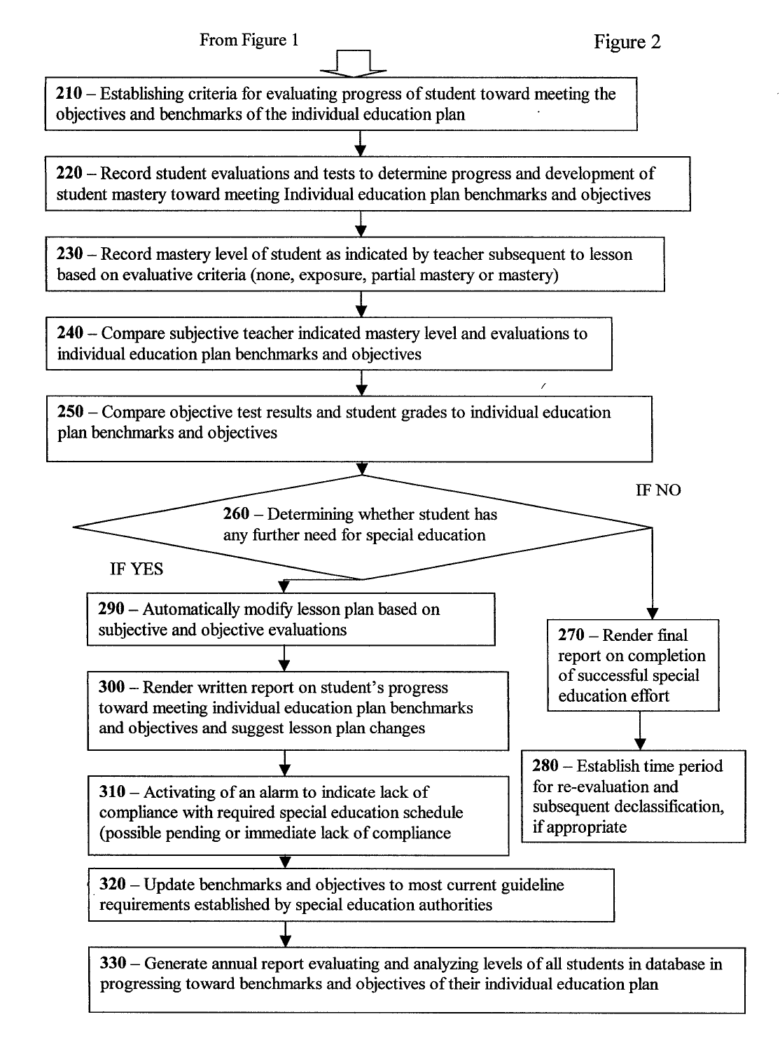

As shown in FIG. 2 once the instructional materials are chosen the student will be placed with a specific teaching group of students currently working on similar lesson plans at step 200. Thereafter at step 210 criteria will be established for evaluating the progress of the student toward meeting the objectives and benchmarks of the IEP. At step 220 student evaluations and tests will be recorded in the database of student personnel to determine progress and development of student mastery toward meeting the IEP benchmarks and objectives.

The mastery level of the student, as indicated by the teacher, will be recorded subsequent to lessons given based on the evaluation criteria at step 230. These evaluated criteria will indicate the level of mastery and will preferably be organized into the levels of: 1. none or no mastery; 2. exposure to the subject matter; 3. partial mastery of the subject matter; 4. mastery of the subject matter.

The teacher indicated mastery level will be compared with the evaluations in order to monitor progress toward the benchmarks and objectives at step 240. At step 250 the objective test results and student grades will be compared to the IEP benchmarks and objectives. Query 260 will be for the purpose of determining whether the student has any further need for special education. If there is no further need a final report can be rendered at step 270 detailing the completion of the successful special education effort. Also a time period for re-evaluation will be established at step 280.

After step 260, if it is determined that there are special education needs still present, the lesson plan will be automatically modified at step 290 based upon the subjective and objective evaluations. At step 300 a written report will be rendered on the student's progress toward meeting the benchmarks and objectives of the individual education plan and lesson plan modifications will be suggested.

Thereafter at step 310 an alarm may be activated if necessary, in order to indicate an “out of compliance” condition relative to the required special education schedule. This “out of compliance” alarm can indicate a possible pending or imminent future lack of compliance or can be a second level alarm which indicates an immediate lack of compliance. Thereafter the benchmarks and objectives, as correlated to the Federal and State guidelines or any other special education guideline authority, can be updated such that they are most current at all times during processing of this system. This is shown at step 320. Step 330 allows the possibility for generating of an annual report which evaluates and analyzes the level of performance of all students in the database in progressing toward the benchmarks and objectives of their own particular individual education plan. Thereafter, in accordance with this method, the process returns to step 130 wherein instructional criteria are evaluated and the method proceeds as detailed hereabove.

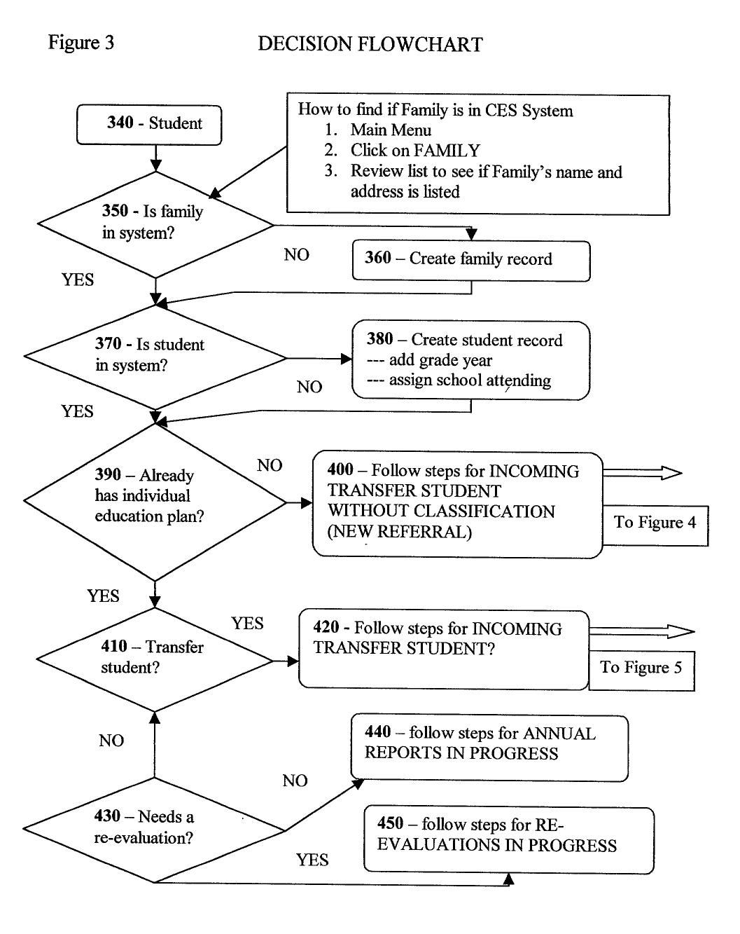

As shown in FIG. 3, at step 340, a particular student is identified. A query 350 is made as to whether the family is located within the system of the present invention. If not, a family record will be created at step 360. After step 360 or after step 350, if the family is already in the system, query 370 will be resolved. This question determines whether the particular student within the family is in the system. If not, the system will proceed to step 380 and a student record will be created including the grade year and the specific school to which the student is attending. Thereafter, if the student is already determined to be in the system at query 370, query 390 will be followed.

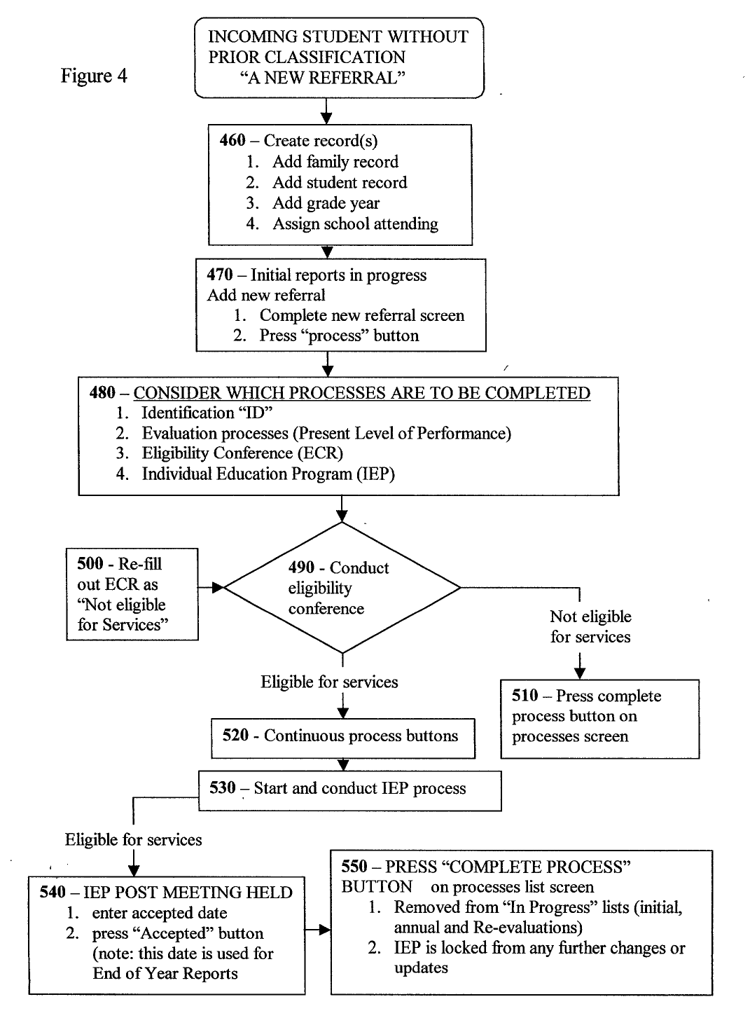

In query 390 a determination is made as to whether the student already has an individual education plan. If not, the system will proceed to step 400 which will follow the process for an incoming transfer student without classification or new referral. The subsequent steps after step 400 are set forth in FIG. 4.

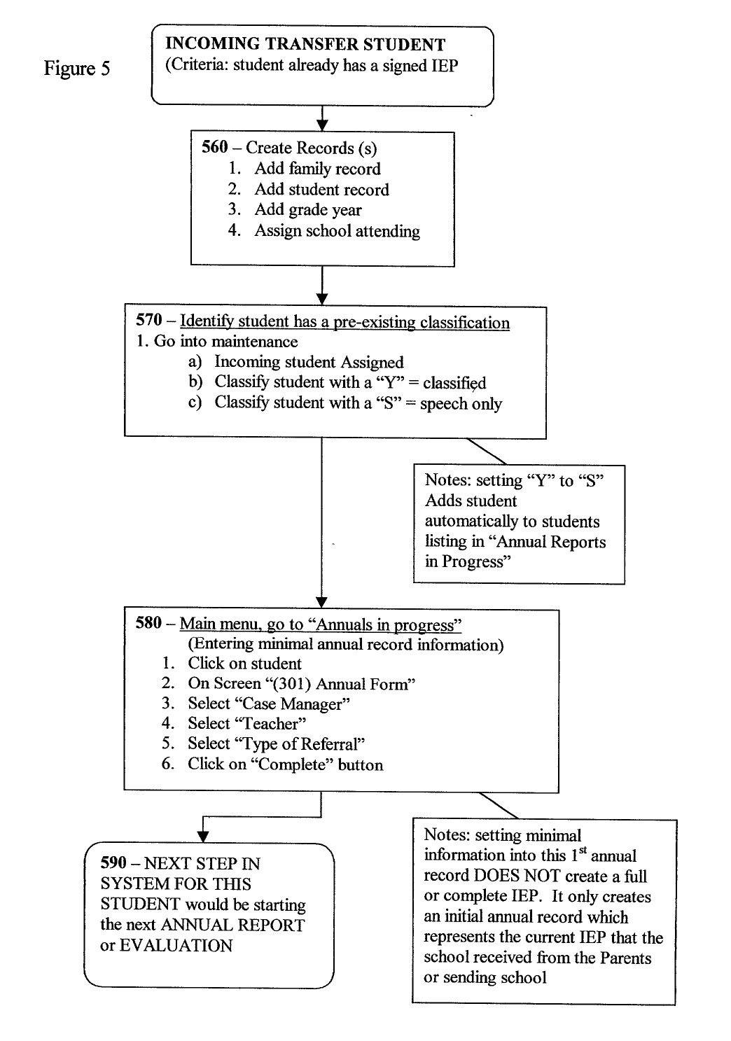

Upon making query 390, if it is determined that the student already has an individual education plan, the process will proceed to query 410 as to whether this is a transfer student. If it is determined that it is a transfer student, step 420 will be followed which details the steps for an incoming transfer student where the student already has a signed individual education plan as shown in FIG. 5. The lower section of FIG. 3 is initiated based upon a determined need for a re-evaluation at step 430. Various conditions can exist which will trigger the need of a re-evaluation. These triggering conditions can comprise a number of different conditions. However, below listed are five specific conditions:

1. three years have passed since the initial evaluation;

2. three years have passed since the last re-evaluation;

3. evaluation requested by parents of the student;

4. student reaches five years of age;

5. educational staff requests a re-evaluation.

If it is determined that an evaluation is not needed, the standard process for generating annual reports set forth at step 440 will be followed. However, if it is determined that a re-evaluation is needed, step 450 will be followed which causes the re-evaluation to occur.

From step 400 in FIG. 3 the process is directed to step 460 in FIG. 4. Thus, once it is apparent that there is an incoming student without prior classification, who has no individual educational plan established, it is then necessary to create a record. This action takes place at step 460 which includes the adding of a family record, the adding of a student record, the adding of the student's grade year and the assignment of the school attending. Thereafter step 470 will take place wherein the initialization of a student's file will occur. This includes adding a new referral, completing the new referral screen and proceeding further. Thereafter step 480 will occur wherein identification information will be inserted, the evaluation process will occur including the preparation of a present level of performance report, an eligibility conference may occur which normally includes educational personnel and the parents of the student and the individual education program will be established. Once these initial steps are completed the eligibility conference will take place at step 490. If there is no need for services the system will progress to step 510 and an appropriate re-evaluation time period will be established. The eligibility conference report preferably written at step 490 requires as much input as possible from the parents, the report results and the special education personnel.

If it is determined that the student is eligible for services, the system will proceed to step 520 which involves the continuous process buttons for the purpose of starting the individual education plan process. The individual education plan will be prepared at query 530 and, if eligible for services, an individual education plan post meeting will be held at step 540. Thereafter the process will be indicated as being completed at step 550 and the student can be removed from the list of students currently in progress of classification from a list of new referrals.

FIG. 5 illustrates the processing step from step 420 required if it is determined that the incoming transfer student already has a signed individual education plan. In that case a record is created at step 560 wherein the family record, the student's record, the grade year and the assigning school attending are all indicated on the student's database record. At step 570 the student is identified as having had a pre-existing classification and is placed in the maintenance system. Thereafter at step 580 the system will evaluate the annual record information in process. At step 590 annual or re-evaluation reports will be determined in a timely manner.

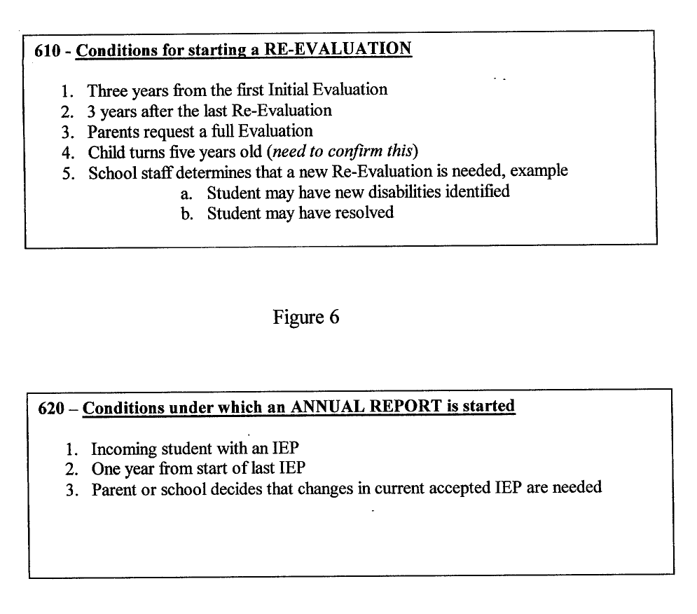

In FIG. 6 conditions are set forth under which a re-evaluation will normally take place. Table 620 sets forth the conditions under which the annual updates are initiated which could be an incoming student with an individual education plan or one year from the start of the last individual education plan or a decision is made by the parent or the school district that changes in the currently accepted individual education plan are needed.

The advantages of the system of the present invention are numerous. Clearly the most important advantage is that this system allows school districts to manage and monitor as well as assess their entire special education program at any given moment while at the same time demonstrating fully their level of compliance with all guidelines set forth by local authorities. The effectiveness of supervision within special education programs is significantly enhanced and meaningful dialogue between the district and the parents is achieved based on this system. This system includes many safeguards for ensuring that no student is, for any reason, ignored. All steps of the initial, annual and re-evaluation process are tracked at all times. Early warning indicators including pending and current out of compliance alarms are included. Correspondence with State authorities and with parents and between administrative personnel is automated. Means are provided for correlating the anecdotal records of a student with all more objective records. An individual educational plan for each individual student is provided which is customized to the particular student for a particular time in his special education.

The system of the present invention is unique in that it takes a special education school district from the point of initial referral for each particular student and documents in anecdotal and objective records all of the transactions and processes that occur for that student during their special education. Further it provides an automated system for timely notification which contains a determination of evaluation form, an evaluation plan, a comprehensive multi disciplinary evaluation report and an initial education plan for special education and related services.

The automatic notification process allows each case manager to know if they are out of compliance for any time line and it warns them a set number of days before any individual reaches an out of compliance status. All correspondence and documents and reports are automatically recorded and entered into the system which tracks all processes and student progress. These documents include all letters, diary entries, scheduled meetings, parental concerns, student progress measures, evaluation results and eligibility determinations. All are tracked carefully within the system.

The special education evaluations are provided for each student and the system is able to develop a list of works in progress. In this manner each case manager is told exactly where the process of referral and evaluation of every student is who is assigned to them. The system allows each case manager to know exactly when and where a case will go out of compliance if such condition can possibly exist. This allows every case manager to closely monitor all work processes for each student for which they are assigned.

This system automatically creates the ability to develop and record class lists, report cards, State and district test results, teacher concerns and parental concerns continuously. A complete list can be provided of all initial, annual and re-evaluation individual education plans. This informs each administrator how each process is moving along categorized by case manager or by teacher or by grade. Instant access to this information provides the highest level of compliance monitoring possible in the special education curriculum environment.

While particular embodiments of this invention have been shown in the drawings and described above, it will be apparent, that many changes may be made in the form, arrangement and positioning of the various elements of the combination. In consideration thereof it should be understood that preferred embodiments of this invention disclosed herein are intended to be illustrative only and not intended to limit the scope of the invention.

I claim:

1. A computerized management system for maintaining compliance with predesignated guidelines for providing individualized education administered to special and regular education students, the method comprising the steps of:
A. providing a computerized database for electronically recording educational information and unique identification information on a number of different special education students;
B. initially evaluating a particular student to determine whether special education needs are present;
C. if special education is not needed, then terminate present student analysis and establish a reminder scheduled for re-evaluating the student in the future;
D. if special education is needed, then prepare an individual education plan customized for the particular student's customized benchmarks and objectives;
E. establishing a unique record in the computerized database for the particular student with special education needs;
F. entering unique identification criteria for the particular student to the student's record in the database;
G. entering a full description of the individual education plan prepared for a particular student into the student's record in the database;
H. evaluating instructional criteria and instructional materials needed in order to facilitate the student in meeting the currently established benchmarks and objectives of the individual education plan;
I creating a specific lesson plan for the student correlated to the instructional criteria and the instructional materials;
J. choosing specific instructional materials based on current lesson plan;
K. placing the student with a specific teaching group of students currently working on similar lessons plans;
L. establishing criteria for evaluating progress of student toward meeting the objectives and benchmarks of individual educational plan;
M. recording student evaluation and test results to determine student mastery level and educational progress toward meeting of benchmarks and objectives of individual education plan;
N. recording student's mastery level as indicated by teacher subsequent to one or more lessons based on evaluative criteria;
O. comparing student's mastery level to individual education plan benchmarks and objectives;
P. determining whether student has further need for any special education;
Q. if no, render final report of completion of successful special education effort and establish time period of re-evaluation;
R. if yes, automatically modify lesson plan based on evaluation;
S. rendering report on student's progress toward meeting individual education plan benchmarks and objectives; and
T. returning to above step of said evaluating instructional criteria need in order to facilitate the student in meeting established benchmarks and objectives of specific individual education plan.

2. A computerized management system for maintaining compliance with predesignated guidelines for providing individualized education administered to special education students as defined in claim 1 wherein said recording student's mastery level as indicated by teacher includes determining the student's mastery level subjectively by teacher evaluation.

3. A computerized management system for maintaining compliance with predesignated guidelines for providing individualized education administered to special education students as defined in claim 1 wherein said recording student's mastery level as indicated by teacher includes determining the student's mastery level objectively by comparing grade and test results to benchmarks and objectives of the individual education plan.

4. A computerized management system for maintaining compliance with predesignated guidelines for providing individualized education administered to special education students as defined in claim 1 further including allocating of the costs of the teaching materials to the database record of the specific student making use thereof performed after said choosing of specific instruction materials based on current lesson plan.

5. A computerized management system for maintaining compliance with predesignated guidelines for providing individualized education administered to special education students as defined in claim 1 further including checking of inventory of instructional materials for items needed for current student.

6. A computerized management system for maintaining compliance with predesignated guidelines for providing individualized education administered to special education students as defined in claim 5 further including completing of a purchase order for any instructional materials not present in inventory thereof.

7. A computerized management system for maintaining compliance with predesignated guidelines for providing individualized education administered to special education students as defined in claim 6 further including providing of instructional materials as ordered.

8. A computerized management system for maintaining compliance with predesignated guidelines for providing individualized education administered to special education students as defined in claim 6 wherein said completing of a purchase order for any instructional materials for a student is performed by the student's teacher.

9. A computerized management system for maintaining compliance with predesignated guidelines for providing individualized education administered to special education students as defined in claim 1 further including providing suggestions for proposed modifications of lesson plans to be performed after said establishing criteria for evaluation progress of student toward meeting the objectives and benchmarks of the individual education plan.

10. A computerized management system for maintaining compliance with predesignated guidelines for providing individualized education administered to special education students as defined in claim 1 wherein said comparing student's mastery level to the benchmarks and objectives of the individual education plan is performed automatically by system software.

11. A computerized management system for maintaining compliance with predesignated guidelines for providing individualized education administered to special education students as defined in claim 1 wherein said determining initially whether current student has present needs for special education includes generating of a present level of performance report to facilitate determining whether special education is warranted.

12. A computerized management system for maintaining compliance with predesignated guidelines for providing individualized education administered to special education students as defined in claim 1 further comprising activating of a first level alarm to indicate imminent possibility of soon becoming out of compliance with mandated special education schedule.

13. A computerized management system for maintaining compliance with predesignated guidelines for providing individualized education administered to special education students as defined in claim 1 further comprising activating of a second level alarm to indicate immediate out of compliance with mandated special education schedule.

14. A computerized management system for maintaining compliance with predesignated guidelines for providing individualized education administered to special education students as defined in claim 1 wherein said comparing student's mastery level to individual education plan benchmarks and objectives includes classifying of student performance relative to the mastery levels according to pre-specified success levels comprising:
A. none;
B. exposure only;
C. partially mastered; and
D. fully mastered.

15. A computerized management system for maintaining compliance with predesignated guidelines for providing individualized education administered to special education students as defined in claim 1 wherein the benchmarks and objectives are continually updated to be maintained current with the latest required special educational guidelines.

16. A computerized management system for maintaining compliance with predesignated guidelines for providing individualized education administered to special education students as defined in claim 1 wherein said determining initially whether current student has present needs for special education includes conducting an initial evaluation meeting of involved special education personnel and parents of current student to provide more detailed analysis for establishing possible need for special education.

17. A computerized management system for maintaining compliance with predesignated guidelines for providing individualized education administered to special education students as defined in claim 1 wherein reevaluation of a student is initiated under any one of a plurality of conditions including:
A. three years have passed since initial evaluation:
B. three years have passed since last re-evaluation'
C. evaluation requested by parents of student;
D. student reaches five years of age; and
E. educational staff requested re-evaluation.

18. A computerized management system for maintaining compliance with predesignated guidelines for providing individualized education administered to special education students as defined in claim 1 further including generating an annual report evaluating and analyzing the levels of all students in the database in progressing toward full mastery of the benchmarks and objectives set forth in each individual education plan.

19. A computerized management system for maintaining compliance with predesignated guidelines for providing individualized education administered to special education students, the method comprising the steps of:
A. providing a computerized database for electronically recording educational information and unique identification information on a number of different special education students;
B. initially evaluating a particular student to determine whether special education needs are present which includes conducting an initial evaluation meeting of involved special education personnel and parents of current student to provide more detailed analysis for establishing possible need for special education;
C. if special education is not needed, then terminate present student analysis and establish a reminder scheduled for re-evaluating the student in the future;
D. if special education is needed, then prepare an individual education plan customized for the particular student's customized benchmarks and objectives;
E. establishing a unique record in the computerized database for the particular student with special education needs;
F. entering unique identification criteria for the particular student to the student's record in the database;
G. entering a full description of the individual education plan prepared for a particular student into the student's record in the database;
H. evaluating instructional criteria and instructional materials needed in order to facilitate the student in meeting the currently established benchmarks and objectives of the individual education plan;
I creating a specific lesson plan for the student correlated to the instructional criteria and the instructional materials designated in the individual education plan;
J. choosing specific instructional materials based on current lesson plan and correlated to the individual education plan;
K. placing the student with a specific teaching group of students currently working on similar lessons plans;
L. establishing criteria for evaluating progress of student toward meeting the objectives and benchmarks of individual educational plan;
M. recording student evaluation and test results to determine student mastery level and educational progress toward meeting of benchmarks and objectives of individual education plan;
N. recording student's mastery level, as indicated by teacher, subsequent to one or more lessons based on evaluative criteria including;
(1) subjectively determining the student's mastery level by teacher evaluation;
(2) objectively determining the student's mastery level by comparing grade and test results to benchmarks and objectives of the individual education plan;
O. comparing student's mastery level automatically by computerized analysis of individual education plan benchmarks and objectives;
P. determining whether student has further need for any special education;
Q. if no, render final report of completion of successful special education effort and establish time period of re-evaluation;
R. if yes, automatically modify lesson plan based on evaluation;
S. rendering report on student's progress toward meeting Individual education plan benchmarks and objectives;
T. activating of a first level alarm to indicate imminent possibility of soon becoming out of compliance with mandated special education schedule or activating of a second level alarm to indicate immediate out of compliance with mandated special education schedule; and
U. returning to above step of said evaluating instructional criteria need in order to facilitate the student in meeting established benchmarks and objectives of specific individual education plan.

20. A computerized management system for maintaining compliance with predesignated guidelines for providing individualized education administered to special education students, the method comprising the steps of:
A. providing a computerized database for electronically recording educational information and unique identification information on a number of different special education students;
B. initially evaluating a particular student to determine whether special education needs are present which includes generating of a present level of performance report to facilitate determining whether special education is warranted and conducting an initial evaluation meeting of involved special education personnel and parents of current student to provide more detailed analysis for etablishing possible need for special education;
C. if special education is not needed, then terminate present student analysis and establish a reminder scheduled for re-evaluating the student in the future;
D. if special education is needed, then prepare an individual education plan customized for the particular student's customized benchmarks and objectives;
E. establishing a unique record in the computerized database for the particular student with special education needs;
F. entering unique identification criteria for the particular student to the student's record in the database;
G. entering a full description of the individual education plan prepared for a particular student into the student's record in the database;
H. evaluating instructional criteria and instructional materials needed in order to facilitate a student to meet the currently established benchmarks and objectives of the individual education plan;
I creating a specific lesson plan for the student correlated to the instructional criteria and the instructional materials as specified in the individual education plan;
J. choosing specific instructional materials based on current lesson plan;
K. allocating of the costs of the teaching materials to the database record of the specific student making use thereof;
L. checking of inventory of instructional materials for items needed for current student;
M. completing of a purchase order by teacher for any instructional materials not present in inventory thereof;
N. providing of instructional materials as ordered to teacher;
O. placing the student with a specific teaching group of students currently working on similar lessons plans;
P. establishing criteria for evaluating progress of student toward meeting the objectives and benchmarks of individual educational plan;
Q. recording student evaluation and test results to determine student mastery level and educational progress toward meeting of benchmarks and objectives of the individual education plan;
R. recording student's mastery level, as indicated by teacher, subsequent to one or more lessons based on evaluative criteria including;
(1) subjectively determining the student's mastery level by teacher evaluation;
(2) objectively determining the student's mastery level by comparing grade and test results to benchmarks and objectives of the individual education plan;
S. comparing student's mastery level automatically by computerized analysis to individual education plan benchmarks and objectives by indicating mastery level as follows:
(1) none;
(2) exposure only;
(3) partially mastered;
(4) fully mastered;
T. determining whether student has further need for any special education;
U. if no, render final report of completion of successful special education effort and establish time period of re-evaluation;
V. if yes, automatically modify lesson plan based on evaluation;
W. rendering written report on student's progress toward meeting individual education plan benchmarks and objectives and suggesting of lesson plan modifications;
X. activating of a first level alarm to indicate imminent possibility of soon becoming out of compliance with mandated special education schedule or activating of a second level alarm to indicate immediate out of compliance with mandated special education schedule;
Y. continual updating of the benchmarks and objectives to be maintained current with the latest required special educational guidelines;
Z. generating a periodic report evaluating and analyzing the levels of all students in the database in progressing toward full mastery of the benchmarks and objectives set forth in each individual education plan; and
AA. returning to above step of said evaluating instructional criteria need in order to facilitate the student in meeting established benchmarks and objectives of specific individual education plan.
